(19) United States
(12) Patent Application Publication
(10) Pub. No.: US 2014/0132108 A1
(43) Pub. Date: May 15, 2014

(54) ELECTRIC MACHINE, SYNCHRONOUS GENERATOR-FIELD POLE, SYNCHRONOUS GENERATOR-ROTOR COMPRISING A PLURALITY OF FIELD POLES AND METHOD FOR PRODUCING A SYNCHRONOUS GENERATOR-FIELD POLE OF AN ELECTRIC MACHINE

(71) Applicants: Torsten Jepsen, Aurich (DE); Matthias Dutsch, Aurich (DE)

(72) Inventors: Torsten Jepsen, Aurich (DE); Matthias Dutsch, Aurich (DE)

(73) Assignee: WOBBEN PROPERTIES GMBH, Aurich (DE)

(21) Appl. No.: 14/124,228

(22) PCT Filed: Jun. 5, 2012
(86) PCT No.: PCT/EP2012/060595

§ 371 Date: Dec. 5, 2013

(30) Foreign Application Priority Data
Jun. 8, 2011 (DE) 10 2011 077 217.0

(51) Int. Cl. H02K 1/26; H02K 15/02

(52) U.S. Cl. CPC H02K 1/26; H02K 15/024
USPC 310/216.012; 310/216.057; 29/598

(57) ABSTRACT

There is provided a synchronous generator rotor pole assembly having a plurality of mutually displaced pole assembly segments which respectively have a plurality of identical pole assembly plates. Each pole assembly plate has a pole shank having a first center line, and a pole head having a second center line. The first and second center lines can be different from each other in adjacent pole assembly segments.

### BACKGROUND

1. Technical Field

The present invention concerns an electric machine, in particular a synchronous generator pole assembly, a synchronous generator rotor having a plurality of pole assemblies and a process for the production of a synchronous generator pole assembly.

2. Description of the Related Art

Electric machines, for example electric generators, in particular synchronous generators, have a generator rotor having a plurality of pole assemblies. Such pole assemblies usually comprise a large number of stamped pole assembly plates. The pole assembly plates are then laminated on to each other and can be for example welded together.

GB 2 389 241 shows a stator of an electric motor having a plurality of pole heads. The pole heads have a large number of pole assembly plates.

In addition as general technological background attention is directed to DE 11 2007 000 201 T5, U.S. Pat. No. 4 616 151, DE 41 14 989 A1, DE 11 2008 002 686 T5 and JP 2007-060800.

EP 1 275 192 B1 shows a pole assembly and a process for the production of a pole assembly. The pole assembly comprises a plurality of stamped pole heads of the pole assembly plates, the pole heads being respectively displaced relative to each other. Each pole assembly plate has a main body (substantially rectangular) and a pole head, wherein the pole head has a curvature and the pole head projects laterally beyond the main body.

The stamping apparatus has a stationary tool which serves to stamp out the free ends of the pole head. A second tool is movable on a straight line transversely relative to the conveying direction of the plate, relative to the first tool, and serves to stamp out all other contours of the pole assembly plate including the radius of the pole head and the side surfaces of the main body.

The pole assembly plates are produced in a three-stage process. First a plate is pushed into the first fixed tool of a stamping apparatus where a first portion of the pole assembly plate is stamped. Then a second portion which is displaced relative to the first portion is stamped out with the second tool. After that, the tool is displaced transversely relative to the conveying direction of the plate and the next pole assembly plate can be stamped, in which case a main body is displaced relative to the pole assembly plate.

Then the stamped pole assembly plates can be stacked and joined together for example by a weld seam. The weld seam is then provided in the region of the main body so that the main bodies of the pole assembly plates are fixed to each other. Because the main bodies are stamped out in stepwise displaced relationship, the consequence of this is that the assembled pole assembly plates are of an arrow-shaped configuration in plan view.

### BRIEF SUMMARY

One or more embodiments of the present invention are directed to a synchronous generator pole assembly and a process for the production of a synchronous generator pole assembly, in particular for a synchronous or ring generator rotor, which permits less expensive and easier manufacture of the pole assemblies.

In one embodiment there is provided a synchronous generator pole assembly having a plurality of mutually displaced pole assembly segments which respectively have a plurality of identical pole assembly plates. Each pole assembly plate has a pole shank having a first center line, and a pole head having a second center line. The first and second center lines or the spacing between the first and second center lines can be different from each other in adjacent pole segments.

In an aspect of the present invention the number of the different pole assembly plates is less than or equal to the number of the mutually displaced pole assembly segments.

In a further aspect of the invention the pole assembly plates in adjacent pole assembly segments respectively have a different angle or a different spacing between the first and second center lines.

In an aspect of the invention the arrangement of the pole assembly segments in plan view is of an arrow-shaped and mirror-symmetrical configuration.

One or more embodiments of the invention also concerns a process for the production of pole assemblies which respectively have a plurality of pole assembly plates. The pole assembly plates respectively have a pole shank and a pole head. A plurality of first pole assembly plates is stamped out by stamping the first portion (pole head) of the pole assembly plates by means of a first fixed tool. The second portions (pole shank) of the pole assembly plates are stamped out by means of a second tool in a first pivotal angle. The second tool is adapted to be pivotable relative to the first tool through an angle. Then the second tool is pivoted relative to the first tool and a second number of pole assembly plates are stamped out, the second tool being in a second pivotal angle. The at least first and second pole assembly plates are respectively assembled to afford at least a first and a second pole assembly segment. The at least first and second pole assembly segments are fixed in mutually relatively displaced relationship (oriented relative to the pole shank).

One or more embodiments of the invention concerns the idea that, instead of a plurality of individual pole assembly plates which are only displaced stepwise being assembled to afford a pole assembly, a plurality of pole assembly segments are provided in stepped or mutually displaced relationship. In that case the pole assembly segments comprise a plurality of identical pole assembly plates. Thus it is not the individual pole assembly plates but the pole assembly segments that are arranged in mutually displaced relationship. That has the advantage that the number of pole assembly plate types to be produced can be considerably reduced as only different pole assembly plate types have to be produced in the maximum number of pole shoe segments.

Optionally the pole assembly plates are of such a configuration that they can be (re-)used by rotation through 180°, in another of the pole assembly segments. Thus the actual number of pole assembly plate types to be stamped out can be further reduced.

In an embodiment of the present invention three differently stamped-out pole assembly plate types are used to afford the entire pole assembly. The three pole assembly plate types can be used for the first three segments and the three pole assembly plate types which are respectively turned through 180° can then be used for the fourth, fifth and sixth segments. Accordingly the six pole assembly segments can be used for a limb of the pole assembly and the other limb of the pole assembly can be based on a correspondingly mirrored sequence of the pole assembly segments of the first arm.

For stamping out the pole assembly plates, in particular for stamping out the head contour, the stamping apparatus is pivoted in a plurality of stages or through a plurality of angles.

The head contour of the pole heads optionally has a first radius and the opposite end of the pole assembly optionally has a second radius, wherein the second radius is smaller than the first radius.

In one embodiment of the invention a stationary tool stamps out the contours of the pole head and a second tool which is movable relative thereto (that is to say pivotable) stamps out the further side surfaces of the pole shank. The second movable tool is pivoted or swiveled relative to the first tool through a predetermined angle. The center line of the pole shank does not have to coincide with the center line of the pole head. Rather, there is an angle between those two center lines, which is achieved by the pivotal movement of the second tool relative to the first.

Contrary to the process described in EP 1 275 192 B1 therefore there is no displacement transversely relative to a feed direction of the plates, but there is a pivotal movement in relation to the feed direction of the plates.

According to one embodiment of the invention the pole assemblies are used in a synchronous generator rotor or in a ring generator rotor. Both the synchronous generator and also the ring generator represent a slowly rotating synchronous generator.

The diameter of the synchronous generator rotor or the ring generator rotor is typically several meters. The synchronous generator or the ring generator has a power output of at least 100 kW, preferably at least 1 MW and can certainly also be 3 MW or up to 10 MW.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic sectional view of a pole assembly according to a first embodiment of the invention,

FIG. 2 shows a plan view of a pole assembly according to the first embodiment of the invention,

FIG. 3 shows a side view of a pole assembly according to the first embodiment of the invention,

FIG. 4 shows a cross-section of a pole assembly plate for a pole assembly according to a second embodiment, and

FIG. 5 shows a cross-section of a further pole assembly plate for a pole assembly according to the second embodiment.

### DETAILED DESCRIPTION

The pole assemblies described hereinafter are used for a synchronous generator rotor or a ring generator rotor.

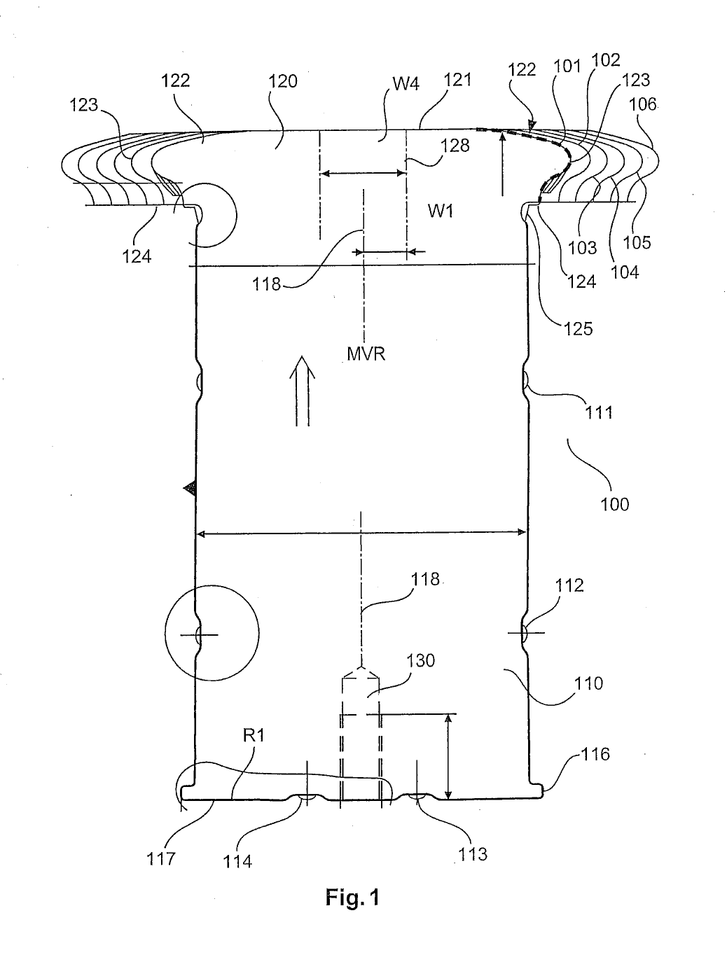

FIG. 1 shows a diagrammatic sectional view of a synchronous generator rotor pole assembly according to a first embodiment of the invention. The pole assembly 100 of the first embodiment has a number of pole segments 101-106. Each pole segment 101-106 has a plurality of pole assembly plates. Each pole assembly plate has a pole head 120 and a pole shank 110. The pole assembly plates are preferably respectively produced in one piece and in particular can be stamped out. The pole shank 110 is of a substantially rectangular configuration and can optionally have two noses 116 in the lower region. In addition there can optionally be provided a plurality of welds 111, 112, 113 and 114. The first end 117 of the pole shank 110 can have a radius of R1.

On each side the pole head 120 has a portion 123 which projects beyond the pole shank 110. The top side 121 of the pole head 120 has a radius of R2.

In one embodiment, each of the pole assembly segments 101-106 has a plurality of identical pole assembly plates. The sole differences between the respective pole assembly plates in the different pole assembly segments lie in the position of the pole shank 110 relative to the two projecting pole head portions 123. The pole assembly plates within a pole assembly segment are not arranged in displaced relationship but oriented relative to each other and one behind the other on the pole shank. Only the pole heads of the pole assembly segments 101-106 are arranged in mutually displaced relationship.

Each of the pole heads is preferably of equal width and each of the pole shanks is also preferably of equal width. It is however also possible for the pole heads and/or the pole shanks to be of differing widths.

The different pole assembly plate types differ from each other only by the relative position of the pole shank relative to the outer portions of the pole head.

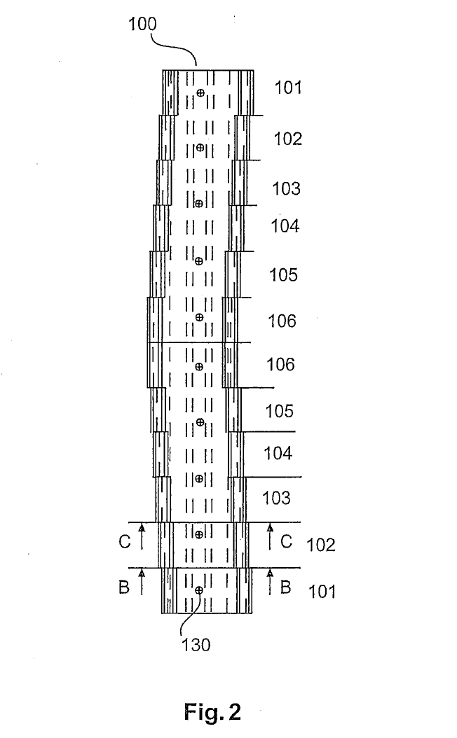

FIG. 2 shows a diagrammatic plan view of a pole assembly according to the first embodiment. In this case the pole assembly has in particular a plurality of pole assembly segments 101-106. Optionally the pole assembly segments 101-106 in the upper arm are arranged in mirror-symmetrical relationship with the pole assemblies 101-106 in the lower arm.

Each of the pole assembly segments 101-106 comprises a plurality of identical pole assembly plates which are welded or joined together. In addition the pole assembly can be constructed with for example only six different pole assembly plate types (corresponding to the pole shoe segments 101-106).

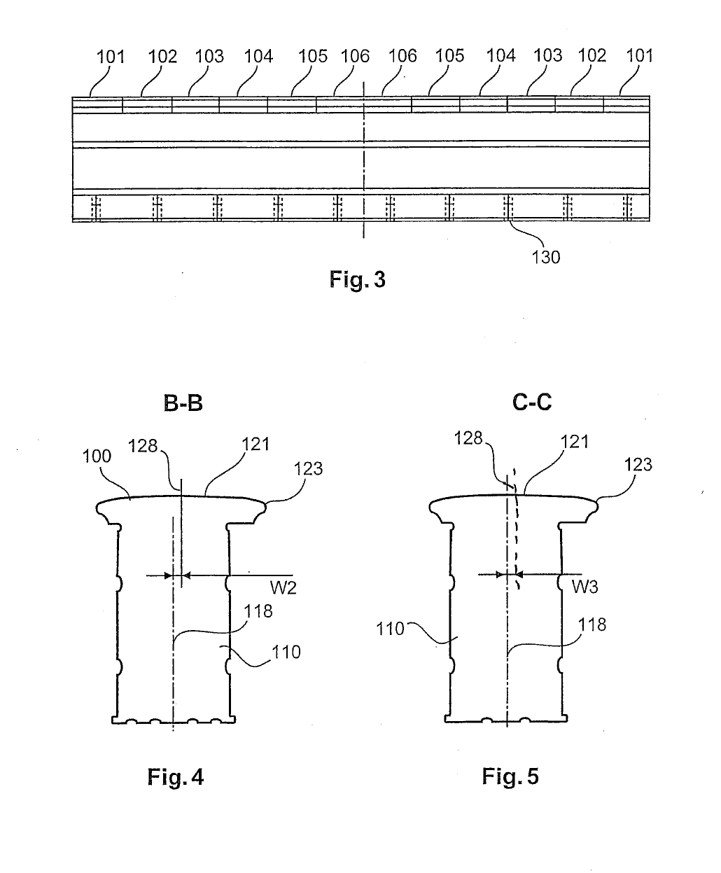

FIG. 3 shows a further side view of the pole assembly of the first embodiment. The pole assembly segments 101-106 are also shown in FIG. 3. The pole assembly segments can be fixed to a rotor body for example by means of the bores 130.

FIG. 4 shows a sectional view through the pole assembly of FIG. 2 along section line B-B. The center line 128 of the pole head 120 differs from the center line 118 of the pole shank through an angle W2 or at a spacing W2.

FIG. 5 shows a cross-section of the pole assembly of FIG. 2 along the section line C-C. In this case a pole assembly plate of the pole assembly segment 103 is shown. In this case the position of the center line 128 of the pole head differs from the position of the center line 118 of the pole shank through an angle W3. In this case the angle W3 is different from the angle W2.

The various pole assembly segments shown in FIG. 2 have respectively identical pole assembly plates. The pole assembly of FIG. 2 can be made up by 2×6 pole assembly segments. Accordingly a maximum of six different pole assembly plate types are required. The pole assembly of FIG. 2 however can also be made up with fewer than six different pole assembly plate types. Optionally the pole assembly of FIG. 2 can be made up with three different pole assembly plate types, each of the pole assembly plate types having a pole head and a pole shank, wherein the pole assembly plate types differ only in the relative position of the pole assembly shank with respect to the pole assembly head. For example the pole assembly segment 106 can be of a configuration of being displaced through 180° relative to the pole assembly segment 101. The pole assembly segment 105 is arranged through 180° relative to the pole assembly segment 102. The pole assembly segment 104 is arranged displaced through 180° relative to the pole assembly segment 103.

In a further aspect of the invention the pole assembly according to a second embodiment which can be based on the first embodiment can be produced with only three different pole assembly plates. To produce the different pole assembly plates a movable stamping tool is pivoted through a pivotal angle before for example the pole shoe shank can be stamped out. To produce the six pole assembly segments shown in FIG. 2 only three pole assembly plate types are required. Those pole assembly plates are made possible by virtue of three different pivotal angles of the second stamping tool, wherein each angle can assume a positive value so that in total six different pole assembly plates can be produced.

One or more embodiments are also directed to a stamping apparatus comprising a first fixed tool to which a plate is fed in the conveying direction. The first tool stamps out a first portion, for example the portions 123. The stamping apparatus further has a second tool which is pivotable or displaceable relative to the first tool and which is used to stamp out the pole shank and/or the pole head portion of the pole shoe portion.

A first step involves stamping out the pole head, that is to say the portions 121, 122 and 123. Then the second tool is pivoted relative to the first tool and the pole shank is stamped out in a next stamping step.

The pole assembly of the first or second embodiment can be produced by three different stamping processes. In the first stamping process firstly the pole head is at least partially stamped out. Then a second stamping tool is displaced relative to the first stamping tool and the pole shank 110 is stamped out. Alternatively to a displacement of the second tool relative to the first tool it is also possible to pivot the second tool relative to the first tool. In an alternative stamping process the respective pole assembly plate types can be stamped out separately, that is to say in a dedicated stamping machine. In such a stamping machine displacement or pivotal movement of a second stamping tool is not necessary but the pole assembly plate can be stamped out in a single stamping step.

The pole head 121-123 can be stamped out in a single step so that the portions 121-123 can be stamped out continuously and in one step. It is thus possible to produce a pole head without an edge in the region of the transition between the portions 121 and 122. That permits tangential transition from the portion 121 on to the portion 122.

The pole assemblies are each provided with a respective winding and electric excitation is fed to the winding so that the pole assembly and the corresponding winding together with an exciter current can produce a magnetic excitation which can cause a magnetic pole. A pole of an electric machine is thus formed from a pole assembly, a winding and an exciter current.

The pole assemblies can be used in a synchronous generator. A pole assembly segment for a permanently excited synchronous generator can be for example of a rectangular cross-sectional configuration, that is to say the pole assembly segments can only be in the form of the pole shank according to the first and second embodiment. To obtain a pole assembly for a permanently excited synchronous generator, a plurality of pole assembly segments is arranged in mutually displaced relationship. In that case each pole assembly segment can be provided by a permanently excited magnet. Accordingly a pole assembly can be formed from a plurality of permanent magnets which are arranged in mutually displaced relationship.

The pole assembly plates can be produced by means of cutting. In that case the cutting operation can include a stamping-out operation, a lasering operation, a water jet cutting operation, a cutting-out operation or a casting operation.

The pole assembly can be provided on a rotor of a synchronous generator. This involves in particular an externally excited synchronous generator. That is achieved in particular by a magnetic pole being obtained, by an electric winding being provided around a pole assembly, the winding being supplied with an exciter current.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A synchronous generator rotor pole assembly comprising:
a plurality of mutually displaced pole assembly segments, each including a plurality of identical pole assembly plates,
wherein each pole assembly plate has a pole shank having a first center line, and a pole head having a second center line, wherein a spacing between the first and second center lines is different for adjacent pole assembly segments.

2. The pole assembly according to claim 1 wherein a number of the different pole assembly plates is less than or equal to a number of the mutually displaced pole assembly segments.

3. The pole assembly according to claim 1 wherein the pole assembly plates in adjacent pole assembly segments respectively have a different angle or a different spacing between the first and second center lines.

4. The pole assembly according to claim 1 wherein an arrangement of the pole assembly segments in plan view is of an arrow-shaped and mirror-symmetrical configuration.

5. A synchronous generator rotor comprising:
a plurality of pole assemblies, each pole assembly including:
a plurality of pole assembly segments, each pole assembly segment including a plurality of pole assembly plates, each pole assembly plate has a pole shank having a first center line, and a pole head having a second center line, wherein adjacent pole assembly segments have a different spacing between the first and second center lines of the respective pole assembly plates.

6. A process for making synchronous generator rotor pole assemblies, the comprising:
stamping out a plurality of first pole assembly plates by stamping out a first portion of the pole assembly plates using a first fixed tool and by stamping out a second portion of the pole assembly plate using a second tool in a first pivotal angle, wherein the second tool is adapted to be relatively displaceable with respect to the first tool through an angle;
pivoting the second tool relative to the first tool;
stamping out a plurality of second pole assembly plates by stamping out a first portion of the pole assembly plates using the first fixed tool and by stamping out a second portion of the pole assembly plate using the second tool, wherein the second stamping tool is in a second pivotal angle;
assembling the first and second pole assembly plates to respectively obtain first and second pole assembly segments, and fixing the first and second pole assembly segments in relatively mutually displaced relationship.

7. The process according to claim 6 wherein assembling the first and second pole assembly plates to respectively obtain first and second pole assembly segments comprises coupling the first pole assembly plates together to obtain the first pole assembly segment and coupling the second pole assembly plates together to obtain the second pole assembly segment.

8. The process according to claim 7 wherein coupling the first pole assembly plates together comprises welding coupling the first pole assembly plates together, and wherein coupling the second pole assembly plates together comprises welding the second pole assembly plates together.
